(19) United States
(12) Patent Application Publication
(10) Pub. No.: US 2017/0274420 A1
(43) Pub. Date: Sep. 28, 2017

(54) METHOD FOR PRODUCING ULTRASONIC TRANSDUCER AND ULTRASONIC TRANSDUCER

(71) Applicant: OLYMPUS CORPORATION, Tokyo (JP)

(72) Inventor: Masaya TODA, Kanagawa (JP)

(73) Assignee: OLYMPUS CORPORATION, Tokyo (JP)

(21) Appl. No.: 15/618,260

(22) Filed: Jun. 9, 2017

Related U.S. Application Data
(63) Continuation of application No. PCT/JP2015/062683, filed on Apr. 27, 2015.

(51) Int. Cl. B06B 1/06; B06B 3/00

(52) U.S. Cl. CPC B06B 1/0611; B06B 3/00; B06B 2201/55

(57) ABSTRACT

A method for producing an ultrasonic transducer including an arrangement determination step of determining an arrangement of piezoelectric elements in a stack on the basis of mechanical quality factors of the respective piezoelectric elements; and an assembly step of assembling the stack in which the piezoelectric elements are arranged according to the arrangement determined in the arrangement determination step, a horn, and a back mass. In the arrangement determination step, the arrangement of the piezoelectric elements is determined so that the difference in mechanical quality factor between the piezoelectric elements adjacent in the longitudinal direction is within 5% of a mean value of the mechanical quality factors of the piezoelectric elements.

### CROSS-REFERENCE TO RELATED APPLICATIONS

This is a continuation of International Application PCT/JP2015/062683, with an international filing date of Apr. 27, 2015, which is hereby incorporated by reference herein in its entirety.

### TECHNICAL FIELD

The present invention relates to a method for producing an ultrasonic transducer and to an ultrasonic transducer.

### BACKGROUND ART

Ultrasonic therapy equipment has been used in procedures such as incision of body tissue (for example, refer to PTL 1). One type of ultrasonic transducer mounted in ultrasonic devices for therapy is high-output bolted Langevin transducers (BLTs), as known in the art (for example, refer to PTL 2).

An ultrasonic transducer generates heat as it vibrates, and the temperature of the handpiece into which the ultrasonic transducer is built rises as a result. In order to keep the surface temperature of the handpiece to a temperature that allows an operator to hold the handpiece with his or her bare hands, an ultrasonic therapy apparatus that includes a handpiece having a grip portion equipped with an air cooling structure, such as heat-dissipating fins, has been proposed (for example, refer to PTL 3).

### CITATION LIST

### Patent Literature

### {PTL 1} The Publication of Japanese Patent No. 4642935

### {PTL 2} Japanese Unexamined Patent Application, Publication No. 61-18299

### {PTL 3} Japanese Unexamined Patent Application, Publication No. 2001-321388

### SUMMARY OF INVENTION

A first aspect of the present invention provides a method for producing an ultrasonic transducer that includes, in order along a longitudinal direction from a distal end side toward a proximal end side, a horn, a stack in which a plurality of piezoelectric elements are stacked in the longitudinal direction, and a back mass, and that generates a longitudinal vibration in the longitudinal direction. The method includes an arrangement determination step of determining an arrangement of the plurality of piezoelectric elements in the stack on the basis of mechanical quality factors of the respective piezoelectric elements; and an assembly step of assembling the stack in which the plurality of piezoelectric elements are arranged according to the arrangement determined in the arrangement determination step, the horn, and the back mass. In the arrangement determination step, the arrangement of the plurality of piezoelectric elements is determined so that a difference in mechanical quality factor between the piezoelectric elements adjacent in the longitudinal direction is within 5% of a mean value of the mechanical quality factors of the plurality of piezoelectric elements.

A second aspect of the present invention provides an ultrasonic transducer including, in order along a longitudinal direction from a distal end side toward a proximal end side, a horn, a stack in which a plurality of piezoelectric elements are stacked in the longitudinal direction, and a back mass. The plurality of piezoelectric elements are arranged so that a difference in mechanical quality factor between the piezoelectric elements adjacent in the longitudinal direction is within 5% of a mean value of the mechanical quality factors of the plurality of piezoelectric elements.

### BRIEF DESCRIPTION OF DRAWINGS

FIG. 1 is a sectional view, taken in the longitudinal axis direction, that shows the overall structure of an ultrasonic transducer according to a first embodiment of the present invention.

FIG. 2 is a simplified diagram showing the overall structure of the ultrasonic transducer illustrated in FIG. 1.

FIG. 3 is a graph showing the distribution of the mechanical loss factor in a stack in the ultrasonic transducer illustrated in FIG. 1.

FIG. 4 is a flowchart showing a method for producing the ultrasonic transducer illustrated in FIG. 1.

FIG. 5 is a simplified diagram showing the overall structure of an ultrasonic transducer according to a second embodiment of the present invention.

FIG. 6 is a graph showing the distribution of the mechanical loss factor in a stack in the ultrasonic transducer illustrated in FIG. 5.

FIG. 7 is a simplified diagram showing the overall structure of an ultrasonic transducer according to a third embodiment of the present invention.

FIG. 8 is a graph showing the distribution of the mechanical loss factor in a stack in the ultrasonic transducer illustrated in FIG. 7.

FIG. 9 is a simplified diagram showing the overall structure of an ultrasonic transducer according to a fourth embodiment of the present invention.

FIG. 10 is a graph showing the distribution of the mechanical loss factor in a stack in the ultrasonic transducer illustrated in FIG. 9.

FIG. 11 is a graph showing the relationship between the distribution of the mechanical loss factor in the stack and the increase in temperature of the ultrasonic transducer.

### DESCRIPTION OF EMBODIMENTS

### First Embodiment

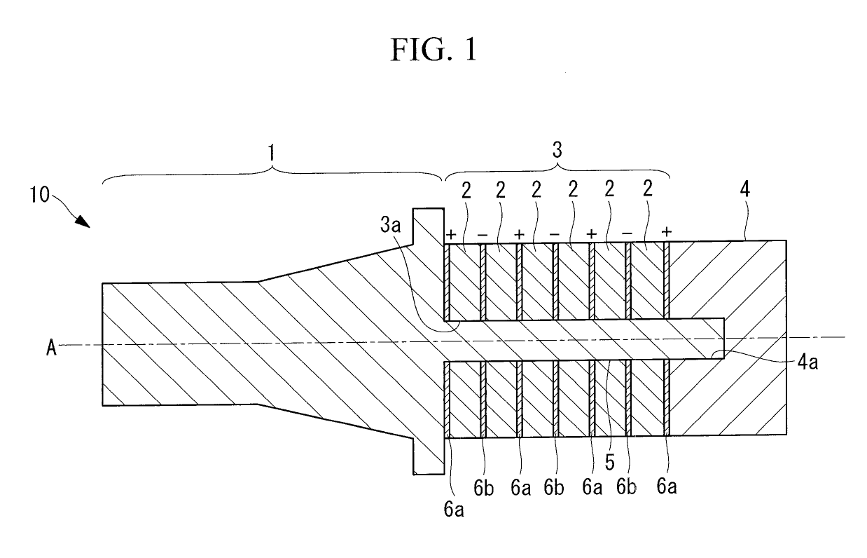

An ultrasonic transducer 10 and a method for producing the ultrasonic transducer 10 according to a first embodiment of the present invention will now be described with reference to FIGS. 1 to 4.

As illustrated in FIG. 1, the ultrasonic transducer 10 according to this embodiment is a bolted Langevin transducer (BLT) and includes a horn 1, a stack 3 in which piezoelectric elements 2 are stacked, and a back mass 4 arranged in that order along a longitudinal axis A from a distal end side to a proximal end side.

The horn 1 has a columnar shape extending along the longitudinal axis A. The horn 1 is shaped so that the area in a horizontal cross-section taken in a direction orthogonal to the longitudinal axis A decreases from the proximal end toward the distal end. The horn 1 is composed of a metal, such as a titanium alloy, that has high strength. A columnar bolt 5 extending along the longitudinal axis A is disposed substantially at the center position of a proximal end surface of the horn 1.

The piezoelectric elements 2 are ring-shaped plate members composed of a piezoelectric material such as lead zirconate titanate (PZT). The stack 3 has a stack structure in which the piezoelectric elements 2 and electrodes 6a or 6b are alternately stacked in the longitudinal axis A direction so that one piezoelectric element 2 is sandwiched between two electrodes 6a and 6b in the longitudinal axis A direction. The electrodes alternately constitute a positive electrode 6a and a negative electrode 6b in the longitudinal axis A direction so that the piezoelectric elements 2 undergo stretching vibrations in the longitudinal axis A direction when AC power is supplied to the electrodes 6a and 6b. An insulator not shown in the drawing is interposed between the stack 3 and the horn 1 and between the stack 3 and the back mass 4 to electrically isolate the stack 3 from the horn 1 and the back mass 4. A bolt hole 3a that penetrates through the stack 3 from the distal end to the proximal end along the longitudinal axis A to allow insertion of the bolt 5 is formed in the stack 3.

The back mass 4 is a columnar member composed of a metal material such as aluminum. A screw hole 4a that is fastened to the bolt 5 is formed in the distal end surface of the back mass 4 and along the longitudinal axis A.

The bolt 5 is inserted into the bolt hole 3a of the stack 3, and the proximal end portion of the bolt 5 protruding from the proximal end surface of the stack 3 is fastened to the back mass 4 so that the stack 3 is strongly clamped from two sides between the horn 1 and the back mass 4.

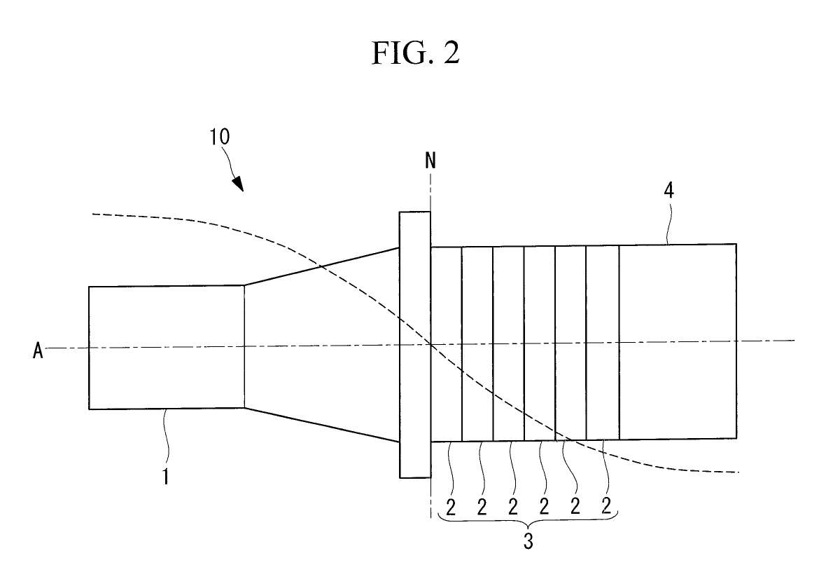

The ultrasonic transducer 10 is of a half-wave resonance type. In other word, the dimension of the ultrasonic transducer 10 in the longitudinal axis A direction is designed to be one half of the wavelength of the resonance frequency of the ultrasonic transducer 10. In this manner, as illustrated in FIG. 2, the ultrasonic transducer 10 undergoes half-wave resonance when AC power having the resonance frequency is supplied to the electrodes 6a and 6b. In half-wave resonance, two anti-nodes appear, at the distal end of the horn 1 and the proximal end of the back mass, respectively, and one node N appears at the boundary between the horn 1 and the stack 2.

Alternatively, the ultrasonic transducer 10 may be of full-wave resonance type whose dimension in the longitudinal axis A direction is equal to the wavelength of the resonance frequency, instead of the half-wave resonance type.

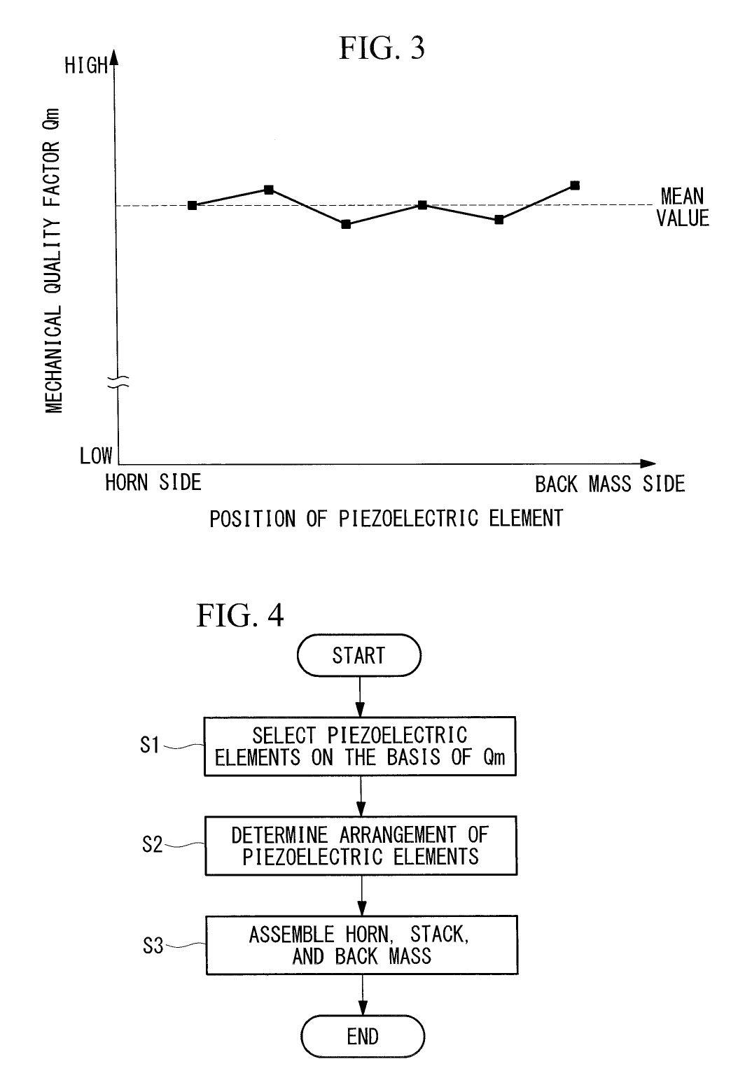

As illustrated in FIG. 3, all of the piezoelectric elements 2 in the stack 3 have the same or close mechanical quality factors Qm (hereinafter simply referred to as “Qm”). Specifically, the Qm of each piezoelectric element 2 is within ±2.5% of the mean value M(Qm) of Qm of all piezoelectric elements 2. Thus, the difference in Qm between two piezoelectric elements 2 adjacent in the longitudinal axis A direction is at most 5% of the mean value M(Qm). In FIG. 3, the data points respectively correspond to the piezoelectric elements 2.

Next, a method for producing the ultrasonic transducer 10 is described.

As illustrated in FIG. 4, a method for producing the ultrasonic transducer 10 according to this embodiment includes a piezoelectric element selection step S1 of selecting piezoelectric elements 2 on the basis of Qm; an arrangement determination step S2 of determining the arrangement of the piezoelectric elements 2 in the stack 3; and an assembly step S3 of assembling the stack 3, the horn 1, and the back mass 4.

Qm of the piezoelectric elements 2 purchased from a manufacturer have a variation of several hundred. In the piezoelectric element selection step S1, Qm of the piezoelectric elements 2 is first measured. Qm is measured by any known method. For example, the resonance frequency fs and the half-value width (f2−f1) of the peak waveform indicating the resonance frequency are measured with an impedance analyzer, a frequency meter, or the like, and Qm is calculated from the expression Qm=fs/(f2−f1). Next, a required number of piezoelectric elements 2 having the same or close Qm are selected for the stack 3 (in this example, six piezoelectric elements). Specifically, six piezoelectric elements 2 are selected so that the variation in Qm among the six piezoelectric elements 2 is within ±2.5% of the mean value M(Qm) of Qm of the six piezoelectric elements 2.

Next, in the arrangement determination step S2, the arrangement of the six piezoelectric elements 2 selected in the piezoelectric element selection step S1 is determined to be a random arrangement.

Next, in the assembly step S3, the six piezoelectric elements 2 and electrodes 6a and 6b are alternately stacked to form the stack 3 so that the six piezoelectric elements 2 are arranged according to the random arrangement determined in the arrangement determination step S2. Next, the bolt 5 of the horn 1 is inserted into the bolt hole 3a in the obtained stack 3, and the back mass 4 is fastened to the tip portion of the bolt 5 protruding from the stack 3 so as to compress the stack 3 in the longitudinal axis A direction. As a result, the ultrasonic transducer 10 is produced.

Next, the operation of the ultrasonic transducer 10 configured as described above is described.

In order to generate ultrasonic vibrations from the ultrasonic transducer 10 according to this embodiment, AC power having a frequency equal or close to the resonance frequency of the ultrasonic transducer 10 is supplied to the electrodes 6a and 6b through an electric cable (not shown) from a power supply (not shown). As a result, the piezoelectric elements 2 each undergo stretching vibrations in the longitudinal axis A direction, and longitudinal vibrations are generated in the stack 3. The longitudinal vibrations generated in the stack 3 are transmitted to the horn 1, and the distal end of the horn 1 vibrates at high frequency in the longitudinal axis A direction.

The relationship between Qm of the piezoelectric elements 2 and the vibration transmission in the stack 3 will now be described.

The mechanical quality factor Qm is a factor that indicates elastic loss that occurs in the piezoelectric element 2 during stretching vibration and is the reciprocal of the mechanical loss factor. The higher the mechanical quality factor Qm, the smaller the elastic loss and the less the attenuation of vibrations. Moreover, less heat is generated. Thus, piezoelectric elements having a Qm as high as 1000 or more are, for example, used as the piezoelectric elements 2 of the ultrasonic transducer 10.

Since the interior of one piezoelectric element is homogeneous, the transmission efficiency of vibrations within one piezoelectric element is high, and vibrations are transmitted substantially without attenuation. Thus, supposing that the stack 3 is constituted of a single, homogeneous piezoelectric element, the entire stack 3 undergoes longitudinal vibration synchronously, and less heat is generated in the stack 3.

An actual stack 3 has a stack structure including several piezoelectric elements 2, and the properties of the piezoelectric elements 2 change discontinuously between one piezoelectric element 2 and other piezoelectric elements 2. At the boundary between the piezoelectric elements 2 whose properties change discontinuously, part of the longitudinal vibrations is lost due to reflection or the like, and thus the vibration transmission efficiency from one piezoelectric element 2 to another adjacent piezoelectric element 2 is decreased. Moreover, heat is generated due to loss of vibrations. That is to say, vibrations reflected at the boundary between the piezoelectric elements 2 interact with other vibrations and generate harmonics that cause heat generation. When there is a difference in Qm between two adjacent piezoelectric elements 2, a sliding motion occurs at the boundary between the two piezoelectric elements 2 due to the difference between the stretching behavior of one of the piezoelectric element 2 and the stretching behavior of the other piezoelectric element 2. As a result, frictional heat is generated.

According to the ultrasonic transducer 10 of this embodiment in which piezoelectric elements 2 having substantially the same Qm are used in the stack 3, the Qm in the stack 3 is substantially uniform. Thus, the stack 3 constituted of several piezoelectric elements 2 displays a behavior similar to a stack constituted of a single piezoelectric element, longitudinal vibrations in the stack 3 are highly efficiently transmitted without attenuation, and heat generation in the stack 3 is suppressed. As a result, an advantage is afforded in that even if the AC power supplied to the electrodes 6a and 6b is increased to increase the output (amplitude of the distal end of the horn 1) of the ultrasonic transducer 10, the ultrasonic transducer 10 can continue to produce high and stable output without an increase in temperature.

Specifically, the stack 3 generates the largest amount of heat among the parts that constitute the ultrasonic transducer 10. Thus, an advantage is afforded in that suppressing the heat generation in the stack 3 results in efficient suppression of an increase in temperature of the entire ultrasonic transducer 10. There is another advantage in that an ultrasonic transducer 10 that generates less heat can be produced by changing merely the way in which the piezoelectric elements 2 are selected in the existing method for producing a BLT.

### Second Embodiment

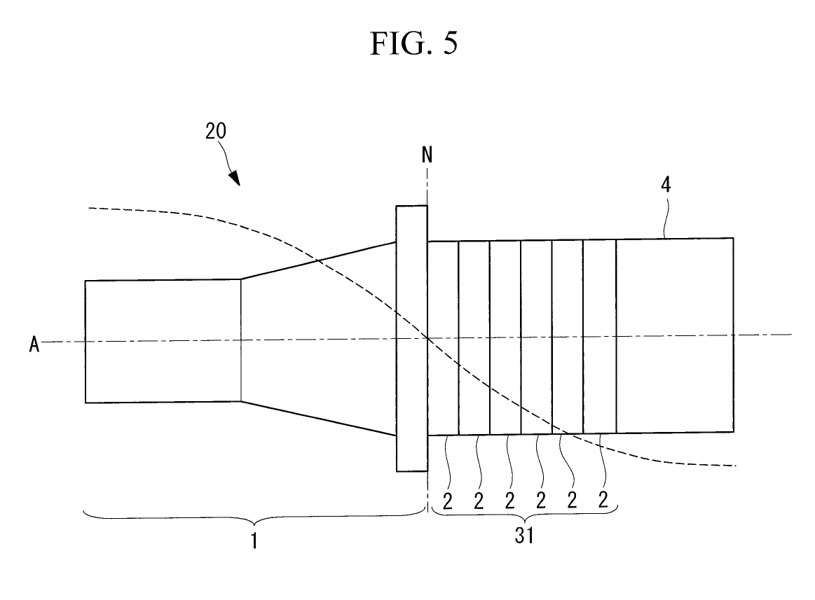

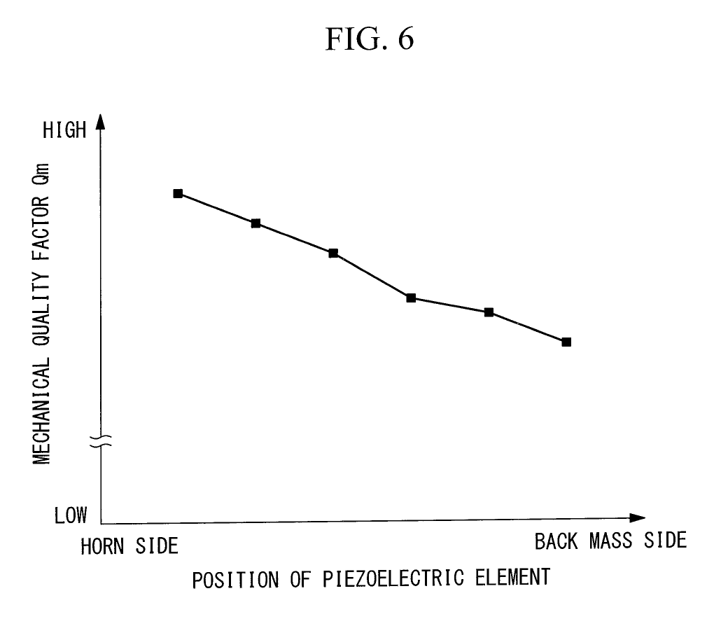

An ultrasonic transducer 20 and a method for producing the ultrasonic transducer 20 according to a second embodiment of the present invention will now be described with reference to FIGS. 5 and 6.

The ultrasonic transducer 20 according to this embodiment differs from the ultrasonic transducer 10 according to the first embodiment in the arrangement of the piezoelectric elements 2 in a stack 31. Thus, in this embodiment, the stack 31 is mainly described. The structures common to the first embodiments are denoted by the same reference numerals and are not described.

As illustrated in FIG. 5, the ultrasonic transducer 20 according to this embodiment is a half-wave resonance type transducer, as with the ultrasonic transducer 10.

As illustrated in FIG. 6, in the stack 31, the piezoelectric elements 2 are arranged so that Qm decreases from the horn 1 side toward the back mass 4 side. Thus, Qm of the piezoelectric element 2 closest to the horn 1 side has the largest Qm and the piezoelectric element 2 closest to the back mass 4 side has the smallest Qm. The difference in Qm between the piezoelectric elements 2 adjacent in the longitudinal axis A direction is within 5% of the mean value M(Qm) of Qm of the six piezoelectric elements 2.

Next, the method for producing the ultrasonic transducer 20 is described.

The method for producing the ultrasonic transducer 20 according to this embodiment includes a piezoelectric element selection step, an arrangement determination step, and an assembly step.

In the piezoelectric element selection step, Qm of the piezoelectric elements 2 is measured, as in the piezoelectric element selection step S1 described in the first embodiment. Next, six piezoelectric elements 2 are selected so that the variation in Qm among the six piezoelectric elements 2 is within ±15% of the mean value M(Qm) of the Qm of the six piezoelectric elements 2 and so that the difference in Qm between adjacent piezoelectric elements 2 arranged in order of the magnitude of the Qm is within 5% of the mean value M(Qm).

Next, in the arrangement determination step, the arrangement of the six piezoelectric elements 2 selected in the selection step is determined so that the Qm decreases from the piezoelectric element 2 closest to the horn 1 side toward the piezoelectric element 2 closest to the back mass 4 side.

Next, in the assembly step, the six piezoelectric elements 2 and electrodes 6a and 6b are alternately stacked to form a stack 3 so that the six piezoelectric elements 2 are arranged according to the arrangement determined in the arrangement determination step. Next, the horn 1, the stack 3, and the back mass 4 are assembled such that the piezoelectric element 2 having the largest Qm is disposed on the horn 1 side and the piezoelectric element 2 having the smallest Qm is disposed on the back mass 4 side.

The ultrasonic transducer 20 according to this embodiment has the following effects in addition to the effects of the first embodiment.

As described above, there is individual variability in Qm of the piezoelectric elements 2, and Qm of the piezoelectric elements 2 purchased from a manufacturer has variation. When only the piezoelectric elements 2 having substantially the same Qm are selected and used, as in the first embodiment, some of the piezoelectric elements 2 purchased cannot be used in the production. However, according to this embodiment, there is an advantage in that piezoelectric elements 2 having different Qm can be used in combination, and thus the purchased piezoelectric elements 2 can be effectively used in production.

Since the piezoelectric element 2 having the largest Qm is closest to the horn 1, longitudinal vibrations generated in the stack 3 are efficiently transmitted to the horn 1. As a result, there is an advantage in that the input/output efficiency of the ultrasonic transducer 20 (the oscillation amplitude of the horn 1 relative to the AC power supplied to the electrodes 6a and 6b) is enhanced, and high output can be obtained while reducing the AC power supplied to the electrode 6a and 6b.

Moreover, the horn 1 has a larger Qm than the piezoelectric elements 2, and vibration loss occurs and heat is generated at the boundary between the horn 1 and the piezoelectric element 2 due to the difference in Qm. Thus, the piezoelectric element 2 having the largest Qm is disposed next to the horn 1 so that the difference in Qm between the horn 1 and the piezoelectric element 2 can be minimized. As a result, there is an advantage in that the vibration transmission efficiency from the stack 3 to the horn 1 can be enhanced, and heat generation can be further suppressed.

### Third Embodiment

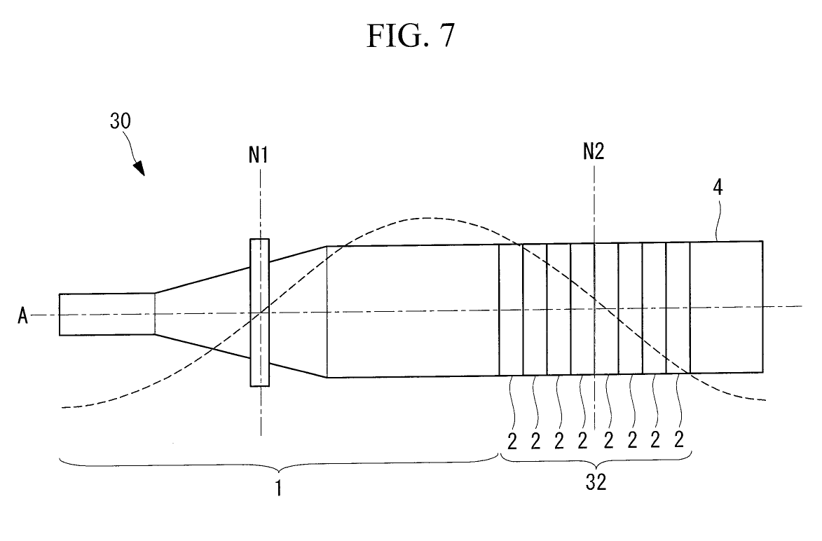

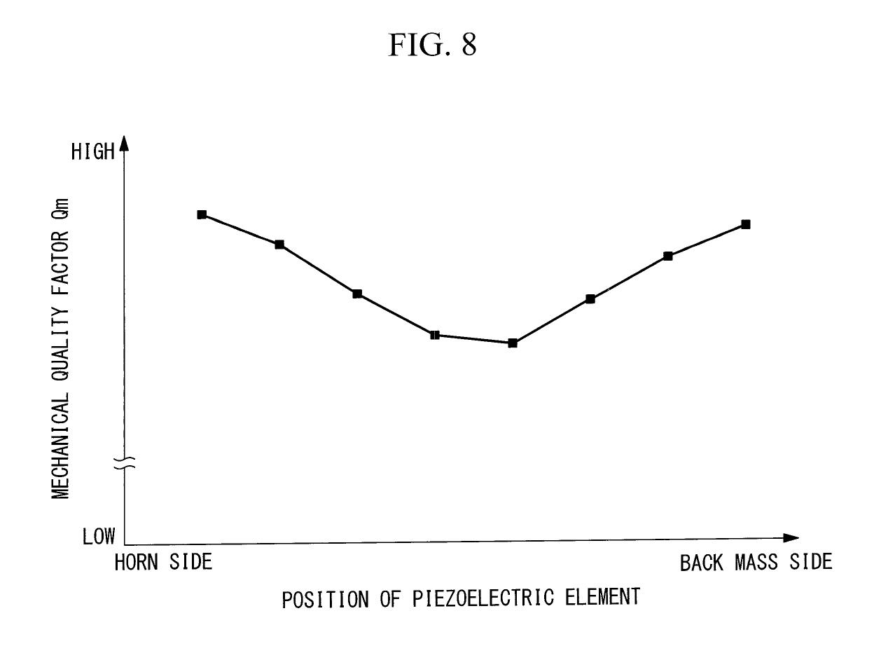

An ultrasonic transducer 30 and a method for producing the ultrasonic transducer 30 according to a third embodiment of the present invention will now be described with reference to FIGS. 7 and 8.

The ultrasonic transducer 30 according to this embodiment differs from the ultrasonic transducer 10 according to the first embodiment in the arrangement of the piezoelectric elements 2 in a stack 32. Thus, in this embodiment, the stack 32 is mainly described. The structures common to the first embodiment are denoted by the same reference numerals and are not described.

As illustrated in FIG. 7, the ultrasonic transducer 30 according to this embodiment has a different overall length from the ultrasonic transducers 10 and 20 of the first and second embodiments and is of a full-wave resonance type. In other words, the dimension of the ultrasonic transducer 30 in the longitudinal axis A direction is equal to the wavelength of the resonance frequency of the ultrasonic transducer 30. In this manner, as illustrated in FIG. 7, the ultrasonic transducer 30 undergoes full-wave resonance when AC power of the resonance frequency is supplied to the electrodes 6a and 6b. In the full-wave resonance, three anti-nodes appear, and two nodes N1 and N2 appear, in the middle position of the horn 1 in the longitudinal direction and the middle position of the stack 3 in the longitudinal direction.

In this embodiment, the stack 32 includes eight piezoelectric elements 2. As illustrated in FIG. 8, the piezoelectric elements 2 are arranged in the stack 32 so that Qm decreases from the piezoelectric element 2 closest to the horn 1 side toward the piezoelectric element 2 positioned at the node N2 and so that Qm increases from the piezoelectric element 2 positioned at the node N2 toward the piezoelectric element 2 closest to the back mass 4 side. In such a case, the piezoelectric element 2 having the largest Qm is preferably positioned closest to the horn 1 side. Moreover, the difference in Qm between adjacent piezoelectric elements 2 in the longitudinal axis A direction is within 5% of the mean value M(Qm) of Qm of the eight piezoelectric elements 2.

Next, the method for producing the ultrasonic transducer 30 is described.

The method for producing the ultrasonic transducer 30 according to this embodiment includes a piezoelectric element selection step, an arrangement determination step, and an assembly step.

In the piezoelectric element selection step, Qm of the piezoelectric elements 2 is measured as in the piezoelectric element selection step S1 described in the first embodiment. Then eight piezoelectric elements 2 are selected so that the variation in Qm of the eight piezoelectric elements 2 is within ±7.5% of the mean value M(Qm) of Qm of the eight piezoelectric elements 2 and so that the difference between Qm of one piezoelectric element 2 and Qm of at least one of any other piezoelectric elements is within 5% of the mean value M(Qm).

Next, in the arrangement determination step, the arrangement of the eight piezoelectric elements 2 selected in the selection step is determined so that Qm is the smallest at the node N2 and Qm increases from the node N2 toward the horn 1 side and toward the back mass 4 side.

Next, in the assembly step, the eight piezoelectric elements 2 and the electrodes 6a and 6b are alternately stacked to form a stack 3 so that the eight piezoelectric elements 2 are arranged according to the arrangement determined in the arrangement determination step. Next, the obtained stack 3, the horn 1, and the back mass 4 are assembled.

The ultrasonic transducer 30 according to this embodiment has the following effects in addition to the effects of the first embodiment.

According to this embodiment in which piezoelectric elements 2 having different Qm are used in combination, as in the second embodiment, there is an advantage that the purchased piezoelectric elements 2 can be effectively used in production.

There is another advantage that because the piezoelectric element 2 having the largest Qm is disposed on the side close to the horn 1, the input/output efficiency of the ultrasonic transducer 30 (the oscillation amplitude of the horn 1 relative to the AC power supplied to the electrodes 6a and 6b) is enhanced, and high output can be obtained, while reducing the AC power supplied to the electrode 6a and 6b.

Furthermore, the piezoelectric element 2 having the smallest Qm is disposed in the stack 3 at the node N2 at which the amplitude of longitudinal vibrations is zero, and the piezoelectric elements 2 having large Qm are disposed at positions where the amplitude is large. As a result, there is an advantage in that the transmission efficiency of longitudinal vibrations can be improved, and the heat generation in the stack 3 can be further decreased.

### Fourth Embodiment

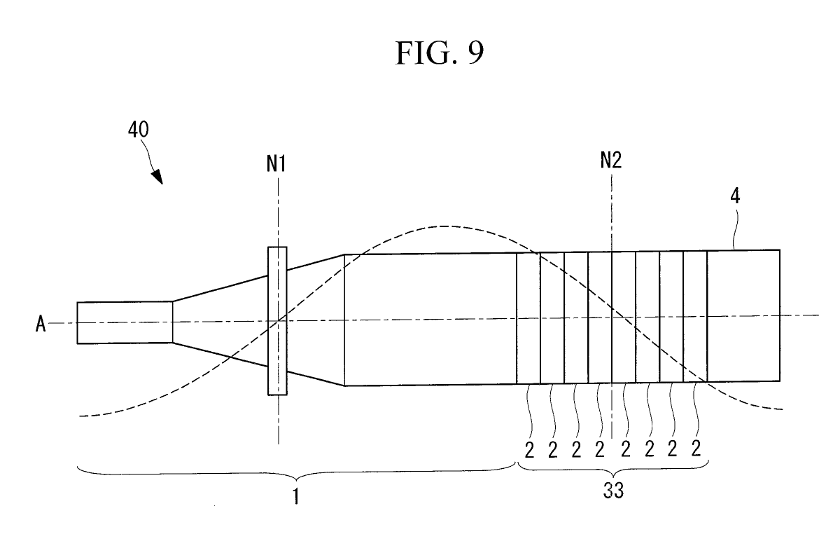

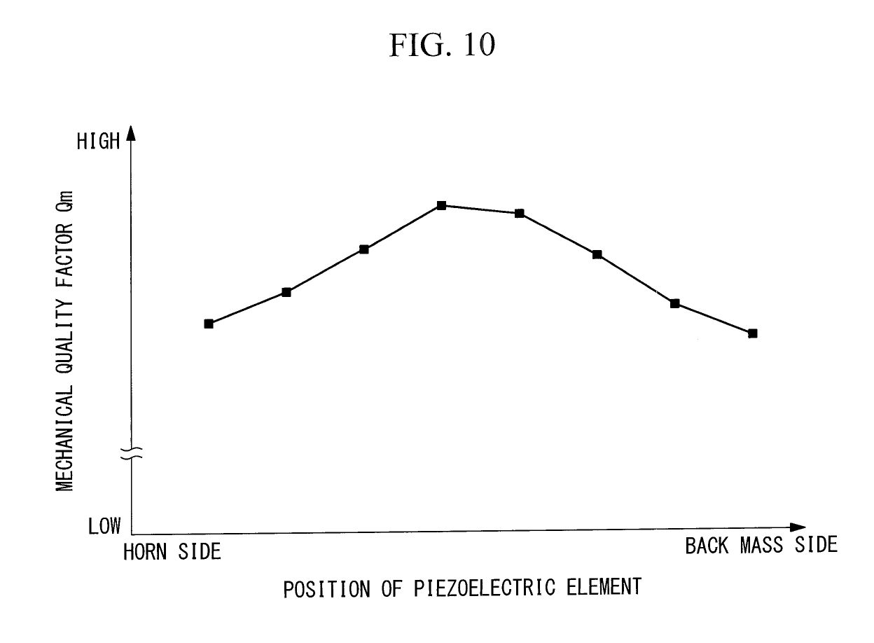

An ultrasonic transducer 40 and a method for producing the ultrasonic transducer 40 according to a fourth embodiment of the present invention will now be described with reference to FIGS. 9 and 10.

The ultrasonic transducer 40 according to this embodiment differs from the ultrasonic transducer 30 according to the third embodiment in the arrangement of the piezoelectric elements 2 in a stack 33. Thus, in this embodiment, the stack 33 is mainly described. The structures common to the third embodiments are denoted by the same reference numerals and are not described.

As illustrated in FIG. 9, the ultrasonic transducer 40 according to this embodiment is of a full-wave resonance type, as with the ultrasonic transducer 30, and the stack 33 includes eight piezoelectric elements 2.

As illustrated in FIG. 10, the piezoelectric elements 2 are arranged in the stack 33 so that Qm increases from the piezoelectric element 2 closest to the horn 1 toward the piezoelectric element 2 positioned at the node N2 and so that Qm decreases from the piezoelectric element 2 at the node 2 toward the piezoelectric element 2 closest to the back mass 4 side. The difference in Qm between the piezoelectric elements 2 adjacent in the longitudinal axis A direction is within 5% of the mean value M(Qm) of Qm of the eight piezoelectric elements 2.

Next, the method for producing the ultrasonic transducer 40 is described.

The method for producing the ultrasonic transducer 40 according to this embodiment includes a piezoelectric element selection step, an arrangement determination step, and an assembly step.

The piezoelectric element selection step of this embodiment is the same as the piezoelectric element selection step described in the third embodiment.

Next, in the arrangement determination step, the arrangement of the eight piezoelectric elements 2 selected in the selection step is determined so that Qm is the largest at the node N2 and so that Qm decreases from the node N2 toward the horn 1 side and toward the back mass 4 side.

Next, in the assembly step, the eight piezoelectric elements 2 and the electrodes 6a and 6b are alternately stacked to form a stack 3 so that the eight piezoelectric elements 2 are arranged according to the arrangement determined in the arrangement determination step. Next, the obtained stack 3, the horn 1, and the back mass 4 are assembled.

The ultrasonic transducer 40 according to this embodiment has the following effects in addition to the effects of the first embodiment.

According to this embodiment in which piezoelectric elements 2 having different Qm are used in combination, as in the second embodiment, there is an advantage that the purchased piezoelectric elements 2 can be effectively used in production.

Next, the relationship between the Qm distribution in the stacks 3, 31, 32, and 33 and the amount of heat generated in the ultrasonic transducers 10, 20, 30, and 40 is described.

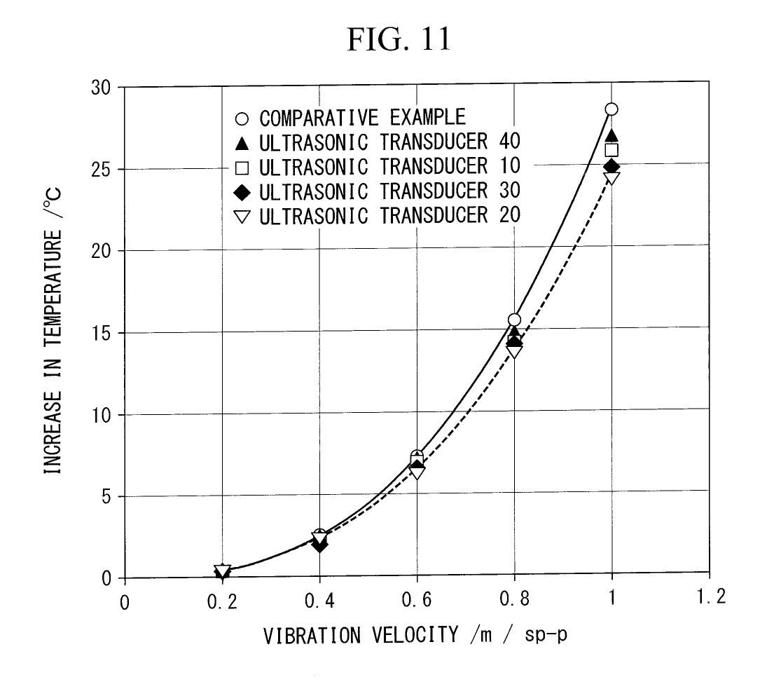

FIG. 11 is a graph showing the results obtained by measuring the temperature increase that occurred due to half-wave resonance or full-wave resonance from the ultrasonic transducers 10, 20, 30, and 40 according to the first to fourth embodiments when the same AC power was fed. The temperature increase of an ultrasonic transducer produced by using randomly selected piezoelectric elements was also measured as a comparative example.

As illustrated in FIG. 11, it is confirmed that the temperature increases in the ultrasonic transducers 10, 20, 30, and 40 according to the embodiments are advantageously small compared to the comparative example. In particular, the temperature increases in the ultrasonic transducers 20 and 30 are small. This confirms that placing a piezoelectric element 2 having a large Qm on the horn 1 side can effectively suppress the generation of heat in the ultrasonic transducers 20 and 30. Moreover, the temperature increase in the ultrasonic transducer 20 is 4° C. lower than that of the comparative example. This confirms that even when AC power supplied to the ultrasonic transducer 20 is increased by 11 W (14%), the temperature increase can be suppressed to about the same as the comparative example.

As a result, the above-described embodiments lead to the following aspects.

A first aspect of the present invention provides a method for producing an ultrasonic transducer that includes, in order along a longitudinal direction from a distal end side toward a proximal end side, a horn, a stack in which a plurality of piezoelectric elements are stacked in the longitudinal direction, and a back mass, and that generates a longitudinal vibration in the longitudinal direction. The method includes an arrangement determination step of determining an arrangement of the plurality of piezoelectric elements in the stack on the basis of mechanical quality factors of the respective piezoelectric elements; and an assembly step of assembling the stack in which the plurality of piezoelectric elements are arranged according to the arrangement determined in the arrangement determination step, the horn, and the back mass. In the arrangement determination step, the arrangement of the plurality of piezoelectric elements is determined so that a difference in mechanical quality factor between the piezoelectric elements adjacent in the longitudinal direction is within 5% of a mean value of the mechanical quality factors of the plurality of piezoelectric elements.

According to the first aspect of the present invention, an ultrasonic transducer can be produced by assembling the stack of piezoelectric elements, the horn, and the back mass in the assembly step in such a way that the stacked structure of the stack is sandwiched between the horn and the back mass on both sides.

In this case, the arrangement of the piezoelectric elements is determined in the arrangement determination step so that the difference in mechanical quality factor between adjacent piezoelectric elements is at most 5% of the mean value. When the piezoelectric elements having the same or close mechanical quality factors are arranged to be adjacent to one another, the vibration transmission efficiency between the piezoelectric elements is improved. As a result, conversion from vibrations to heat is suppressed, and less heat is generated from the ultrasonic transducer. Thus, the temperature increase in the ultrasonic transducer caused by vibrations can be suppressed and the ultrasonic transducer can continue to stably operate with high output.

In the first aspect described above, a piezoelectric element selection step of selecting the plurality of piezoelectric elements on the basis of mechanical quality factors may be included, and, in the piezoelectric element selection step, the plurality of piezoelectric elements may be selected so that a variation in mechanical quality factors of the plurality of piezoelectric elements with respect to a mean value of the mechanical quality factors of the plurality of piezoelectric elements is within ±2.5%. Furthermore, in the arrangement determination step, an arrangement of the plurality of piezoelectric elements selected in the piezoelectric element selection step may be determined.

In this manner, the difference in mechanical quality factor between the adjacent piezoelectric elements is always within 5%. Thus, in the arrangement determination step, the arrangement of the piezoelectric elements can be determined to be a random arrangement.

In the first aspect described above, in the arrangement determination step, an arrangement of at least some of the plurality of piezoelectric elements on the horn side may be determined so that the mechanical quality factor decreases from the horn side toward the back mass side.

In this manner, because the piezoelectric element having the largest mechanical quality factor is disposed closest to the horn, the longitudinal vibrations generated in the stack are efficiently transmitted to the horn. Thus, the input/output efficiency (amplitude of the longitudinal vibrations relative to the supplied power) can be improved, and the power needed to drive the ultrasonic transducer can be reduced. Since the difference in mechanical quality factor between the horn and the piezoelectric element adjacent to the horn is decreased, less heat is generated at the boundary between the horn and the piezoelectric element, and thus heat generation in the ultrasonic transducer can be further suppressed.

In the first aspect described above, the ultrasonic transducer may be of a half-wave resonance type, and, in the arrangement determination step, an arrangement of the plurality of piezoelectric elements may be determined so that the mechanical quality factor decreases from the piezoelectric element closest to the horn toward the piezoelectric element closest to the back mass.

In this manner, heat generation in the ultrasonic transducer can be further suppressed, and a higher input/output efficiency can be obtained.

In the first aspect described above, the ultrasonic transducer may be of a full-wave resonance type, and, in the arrangement determination step, an arrangement of the plurality of piezoelectric elements may be determined so that the mechanical quality factor decreases from the piezoelectric element closest to the horn toward the piezoelectric element positioned at a node of the longitudinal vibration and so that the mechanical quality factor increases from the piezoelectric element positioned at the node of the longitudinal vibration toward the piezoelectric element closest to the back mass.

In this manner, heat generation in the ultrasonic transducer can be further suppressed, and a higher input/output efficiency can be obtained.

In the first aspect described above, the ultrasonic transducer may be of a full-wave resonance type, and, in the arrangement determination step, an arrangement of the plurality of piezoelectric elements may be determined so that the mechanical quality factor increases from the piezoelectric element closest to the horn toward the piezoelectric element positioned at an anti-node of the longitudinal vibration and so that the mechanical quality factor decreases from the piezoelectric element positioned at the anti-node of the longitudinal vibration toward the piezoelectric element closest to the back mass.

In this manner, heat generation in the ultrasonic transducer can be further suppressed.

A second aspect of the present invention provides an ultrasonic transducer including, in order along a longitudinal direction from a distal end side toward a proximal end side, a horn, a stack in which a plurality of piezoelectric elements are stacked in the longitudinal direction, and a back mass. The plurality of piezoelectric elements are arranged so that a difference in mechanical quality factor between the piezoelectric elements adjacent in the longitudinal direction is within 5% of a mean value of the mechanical quality factors of the plurality of piezoelectric elements.

In the second aspect described above, a variation in mechanical quality factor of the plurality of piezoelectric elements with respect to a mean value of the mechanical quality factors of the plurality of piezoelectric elements may be within ±2.5%.

In the second aspect described above, the plurality of piezoelectric elements may be arranged so that the mechanical quality factor decreases from the piezoelectric element closest to the horn toward the piezoelectric element positioned at an anti-node of longitudinal vibration in the longitudinal direction.

In the second aspect described above, the ultrasonic transducer may be of a half-wave resonance type, and, the plurality of piezoelectric elements may be arranged so that the mechanical quality factor decreases from the piezoelectric element closest to the horn toward the piezoelectric element closest to the back mass.

In the second aspect described above, the ultrasonic transducer may be of a full-wave resonance type, and, the plurality of piezoelectric elements may be arranged so that the mechanical quality factor decreases from the piezoelectric element closest to the horn toward the piezoelectric element positioned at an anti-node of the longitudinal vibration and so that the mechanical quality factor increases from the piezoelectric element positioned at the anti-node of the longitudinal vibration toward the piezoelectric element closest to the back mass.

In the second aspect described above, the ultrasonic transducer may be of a full-wave resonance type, and the plurality of piezoelectric elements may be arranged so that the mechanical quality factor increases from the piezoelectric element closest to the horn toward the piezoelectric element positioned at an anti-node of longitudinal vibration in the longitudinal direction and so that the mechanical quality factor decreases from the piezoelectric element positioned at the anti-node of the longitudinal vibration toward the piezoelectric element closest to the back mass.

The advantageous effects provided by the present invention are suppression of a temperature increase caused by vibrations and stable operation of the ultrasonic transducer with high output power.

### REFERENCE SIGNS LIST

10, 20, 30, 40 ultrasonic transducer
1 horn
2 piezoelectric element
3, 31, 32, 33 stack
4 back mass
5 bolt
6a, 6b electrode
S1 piezoelectric element selection step
S2 arrangement determination step
S3 assembly step

1. A method for producing an ultrasonic transducer that includes, in order along a longitudinal direction from a distal end side toward a proximal end side, a horn, a stack in which a plurality of piezoelectric elements are stacked in the longitudinal direction, and a back mass, and that generates a longitudinal vibration in the longitudinal direction, the method comprising:
an arrangement determination step of determining an arrangement of the plurality of piezoelectric elements in the stack based on the mechanical quality factors of the respective piezoelectric elements; and
an assembly step of assembling the stack in which the plurality of piezoelectric elements are arranged according to the arrangement determined in the arrangement determination step, the horn, and the back mass,
wherein, in the arrangement determination step, the arrangement of the plurality of piezoelectric elements is determined so that a difference in the mechanical quality factor between piezoelectric elements adjacent in the longitudinal direction is within 5% of a mean value of the mechanical quality factors of the plurality of piezoelectric elements, and an arrangement of at least some of the plurality of piezoelectric elements on the horn side is determined so that the mechanical quality factor decreases or increases from the utmost horn side toward the back mass side.

2. A method for producing an ultrasonic transducer according to claim 1, wherein:
the ultrasonic transducer is of a half-wave resonance type, and
in the arrangement determination step, an arrangement of the plurality of piezoelectric elements is determined so that the mechanical quality factor decreases from the piezoelectric element closest to the horn toward the piezoelectric element closest to the back mass.

3. A method for producing an ultrasonic transducer according to claim 1, wherein:
the ultrasonic transducer is of a full-wave resonance type, and
in the arrangement determination step, an arrangement of the plurality of piezoelectric elements is determined so that the mechanical quality factor decreases from the piezoelectric element closest to the horn toward the piezoelectric element positioned at a node of the longitudinal vibration and so that the mechanical quality factor increases from the piezoelectric element positioned at the node of the longitudinal vibration toward the piezoelectric element closest to the back mass.

4. A method for producing an ultrasonic transducer according to claim 1, wherein:
the ultrasonic transducer is of a full-wave resonance type, and
in the arrangement determination step, an arrangement of the plurality of piezoelectric elements is determined so that the mechanical quality factor increases from the piezoelectric element closest to the horn toward the piezoelectric element positioned at a node of the longitudinal vibration and so that the mechanical quality factor decreases from the piezoelectric element positioned at the node of the longitudinal vibration toward the piezoelectric element closest to the back mass.

5. An ultrasonic transducer comprising, in order along a longitudinal direction from a distal end side toward a proximal end side, a horn, a stack in which a plurality of piezoelectric elements are stacked in the longitudinal direction, and a back mass, and generating a longitudinal vibration in the longitudinal direction,
wherein the plurality of piezoelectric elements are arranged so that a difference in mechanical quality factor between the piezoelectric elements adjacent in the longitudinal direction is within 5% of a mean value of the mechanical quality factors of the plurality of piezoelectric elements, and
wherein at least some of the plurality of piezoelectric elements on the horn side are arranged so that the mechanical quality factor decreases or increases from the piezoelectric element closest to the horn toward the back mass side.

6. The ultrasonic transducer according to claim 5,
wherein the ultrasonic transducer is of a half-wave resonance type, and
the plurality of piezoelectric elements are arranged so that the mechanical quality factor decreases from the piezoelectric element closest to the horn toward the piezoelectric element closest to the back mass.

7. The ultrasonic transducer according to claim 5,
wherein the ultrasonic transducer is of a full-wave resonance type, and
the plurality of piezoelectric elements are arranged so that the mechanical quality factor decreases from the piezoelectric element closest to the horn toward the piezoelectric element positioned at a node of the longitudinal vibration and so that the mechanical quality factor increases from the piezoelectric element positioned at the node of the longitudinal vibration toward the piezoelectric element closest to the back mass.

8. The ultrasonic transducer according to claim 5,
wherein the ultrasonic transducer is of a full-wave resonance type, and
the plurality of piezoelectric elements are arranged so that the mechanical quality factor increases from the piezoelectric element closest to the horn toward the piezoelectric element positioned at a node of longitudinal vibration and so that the mechanical quality factor decreases from the piezoelectric element positioned at the node of the longitudinal vibration toward the piezoelectric element closest to the back mass.
